(19) United States
(12) Patent Application Publication
(10) Pub. No.: US 2017/0200210 A1
(43) Pub. Date: Jul. 13, 2017

(54) SYSTEMS AND METHODS FOR TRANSFERRING GOODS BETWEEN MULTIPLE ENTITIES

(71) Applicant: Dmitry Atlasman, Beer Sheva (IL)

(72) Inventor: Dmitry Atlasman, Beer Sheva (IL)

(21) Appl. No.: 15/403,232

(22) Filed: Jan. 11, 2017

Related U.S. Application Data
(60) Provisional application No. 62/276,997, filed on Jan. 11, 2016.

(51) Int. Cl. G06Q 30/06

(52) U.S. Cl. CPC G06Q 30/0611

(57) ABSTRACT

The present disclosure herein relates to systems and methods for managing a plurality of exchange-proposals associated with trading parties to allow transferring of goods between multiple users using a trading platform. The users may be using communication devices installable with appropriate software application, connected via a network with the trading platform such that the exchange graphs are generated allowing goods to be exchanged, enabling each user to receive a set of requested goods and provides a set of offered goods. The trading platform is operable to receive a plurality of exchange-proposals, identify a plurality of matching-pairs and establish a trading network of connected exchange-proposals, linked by said matching-pairs. Thus, the trading platform is operable to facilitate transfer of items between multiple trading parties.

### CROSS-REFERENCE TO RELATED APPLICATIONS

The present application claims the benefit of priority from U.S. Provisional Patent Application No. 62/276,997, filed Jan. 11, 2016, the contents of which are incorporated by reference herein in their entirety.

### FIELD OF THE DISCLOSURE

The disclosure herein relates to systems and methods for transferring goods between multiple users. In particular, the disclosure is associated with a trading platform managing a plurality of exchange-proposals associated with trading parties. The trading parties are connected via a network such that exchange graphs are generated allowing goods to be exchanged so that each trading party may receive a set of requested goods and provides a set of proffered goods.

### BACKGROUND OF THE INVENTION

Bartering is the act of trading services or goods with another party without the use of money. The practice of bartering is an age-old art of exchanging goods and services known for many centuries, involving mainly people in the same area. Bartering, for example, has been revived and became popular in the 1930s during the Great Depression, used to obtain food and various other services. Recently, along with the influence of modern life, advanced technology and social networking the idea of trading within a local or a global community has been enhanced, receiving a new modern facing.

Combining modern life, materialistic and ownership-based society with advanced technology, world of internet and computing contributed to developing of bartering and swapping systems via web-sites and mobile applications to provide online trading and exchange of goods and services.

The normal practice of such web-sites may require the user to post an offer for exchange and barter services. This offer is accessible to other users that may view the posted offer and further contact via the web-site system, if interested. For example, Craigslist is not only a free and widely known place for buying and selling of goods and services, but also provide bartering services as well. Thus, when one finds an item or service of interested, one may contact that person and make the seller or buyer an offer. Swap.com is another example of a trading site that focuses on the trading of books, CD's, movies, and video games.

Yet, the need is there for an exchange platform for trading goods and services between multiple trading parties in an automated manner. The invention described herein addresses the above-described needs.

### SUMMARY OF THE INVENTION

According to one aspect of the current invention, a method is taught for facilitating transfer of items between multiple parties. The method comprises receiving a plurality of exchange-proposals, each exchange-proposal associated with a trading-party and characterized by a request-set including at least one requested-item, and a proffered-set including at least one proffered-item. The method further includes identifying a plurality of matching-pairs, each the matching-pair linking at least one proffered-item selected from the proffered-set of a first exchange-proposal and at least one matching requested-item selected from the requested-set of a second exchange-proposal. The method still further includes establishing a trading-network of connected exchange-proposals, linked by the matching-pairs such that each the proffered-item of each the connected exchange-proposal is paired with a requested-item from another connected exchange-proposal and each the requested-item of each connected exchange-proposal is paired with a proffered-item from another connected exchange-proposal.

Optionally, the method further includes collecting from each trading-party associated with each the connected exchange-proposal in the trading-network the proffered-items in its associated proffered-set; and providing to each trading-party associated with each the connected exchange-proposal in the trading-network the requested-items in its associated requested-set.

Where appropriate, the step of establishing a trading-network comprises generating at least one exchange-graph having trading-nodes and trading-edges wherein each trading-node corresponds with a single exchange-proposal and each the trading-edge corresponds with a matching-pair linking two the trading-nodes.

Duplicates may be avoided by identifying at least two identical exchange-graphs; and removing all duplicates of the exchange-graphs. Furthermore, any exchange-graph maybe removed if all of its trading-nodes are a subset of the trading-nodes of another exchange-graph.

Where required, the step of establishing a trading-network further comprises generating at least one open exchange-graph characterized by having at least one trading-node corresponding to an unexhausted exchange-proposal having at least one unbound requested-item or at least one unbound proffered-item which is not linked to any matching-pair.

Optionally, the step of establishing a trading-network comprises receiving a new exchange-proposal; identifying exchange-graphs which include at least one matching requested-item corresponding to at least one proffered-item in the proffered set of the new exchange-proposal, and for each the at least one matching requested-item, creating a new matching-pair between the at least one matching requested-item and the at least one proffered-item of the new exchange-proposal; and identifying exchange-graphs which include at least one matching proffered-item corresponding to at least one requested-item in the requested set of the new exchange-proposal, and for each the at least one matching proffered-item, creating a new matching-pair between the at least one matching proffered-item and the at least one requested-item of the new exchange-proposal.

Additionally or alternatively, the step of establishing a trading-network further comprises creating a merged exchange-graph by connecting a first exchange-graph and a second exchange-graph. Optionally, the step of connecting the first exchange-graph and the second exchange-graph comprises creating a matching-pair matching at least one proffered-item from one exchange-graph and at least one matching requested-item from the other exchange-graph. Additionally or alternatively, the step of connecting the first exchange-graph and the second exchange-graph comprises: creating a first matching-pair linking a new exchange-proposal to at least one proffered-item or requested-item from the first exchange-graph, and creating a second matching-pair linking the new exchange-proposal to at least one proffered-item or requested-item from the second exchange-graph.

As appropriate, creating a merged exchange-graph further may comprise removing incompatible trading-nodes in the first exchange-graph which include proffered-items in common or requested-items in common with at least one corresponding incompatible trading-node in the second exchange-graph. Furthermore, connecting the open exchange-graphs may further comprise removing any trading-nodes connected to the first exchange-graph or the second exchange-graph via the incompatible trading-nodes.

It is further noted that the step of establishing a trading-network may further comprises identifying incompatible trading-nodes in a first open exchange-graph which include proffered-items in common or requested-items in common with at least one corresponding incompatible trading-node in the second open exchange-graph; and, for each combination of incompatible trading-nodes in the first open exchange-graph, generating a merged exchange-graph. The merged exchange-graph may be generated by: removing the combination of incompatible trading-nodes from a copy of the first open exchange-graph, (or alternatively removing all the incompatible trading-nodes from a copy of the first open exchange-graph except for the trading-nodes of the combination); removing from a copy of the second open exchange-graph all incompatible trading-nodes corresponding to the incompatible trading-nodes remaining in the copy of the first open exchange graph; removing any trading-nodes which were connected to the first open exchange-graph or the second open exchange-graph via the incompatible trading-nodes; and connecting the copy of the first open exchange-graph and the copy of the second open exchange-graph.

Accordingly, where required, the step of connecting the copy of the first open exchange-graph and the copy of the second open exchange-graph may comprise creating a matching-pair matching at least one proffered-item from one open exchange-graph and at least one matching requested-item from the other open exchange-graph. Additionally or alternatively, the step of connecting the copy of the first open exchange-graph and the copy of the second open exchange-graph comprises: creating a first matching-pair linking a new exchange-proposal to at least one proffered-item or requested-item from the first open exchange-graph, and creating a second matching-pair linking the new exchange-proposal to at least one proffered-item or requested-item from the second open exchange-graph.

Again, duplicates may be avoided by removing any merged exchange-graph all of whose trading-nodes are a subset of the trading-nodes of another merged exchange-graph. Additionally or alternatively, duplicates may be avoided by identifying at least two identical merged exchange-graphs; and removing all duplicates of the merged exchange-graphs.

It is according to another aspect of the invention to present a trading platform for managing transfer of items between multiple trading-parties. The trading platform may include various features including the a plurality of computing devices installable with a software application, each device associated with at least one trading party and operable to present an exchange-proposal characterized by a request-set including at least one requested-item and a proffered-set including at least one offered-item. The trading platform may also include at least one trading server in communication with each of the plurality of computing devices via a communication network and the software application.

The at least one trading server operable to execute instructions directed to receive a plurality of exchange-proposals, each exchange-proposal associated with a trading-party; to identify a plurality of matching-pairs, each the matching-pair linking at least one proffered-item selected from the proffered-set of a first exchange-proposal and a matching requested-item selected from the requested-set of a second exchange-proposal; and to establish a trading-network of connected exchange-proposals, linked by the matching-pairs such that each the proffered-item of each the connected exchange-proposal is paired with at least one requested-item from another connected exchange-proposal and each the requested-item of each connected exchange-proposal is paired with at least one proffered-item from another connected exchange-proposal.

Optionally, the trading platform may include a delivery management system for coordinating delivery of the traded items between trading parties. Accordingly, the trading platform may include a collection mechanism for collecting from each trading-party associated with each the connected exchange-proposal in the trading-network the proffered-items in its associated proffered-set; and a delivery mechanism for providing to each trading-party associated with each the connected exchange-proposal in the trading-network the requested-items in its associated requested-set.

### BRIEF DESCRIPTION OF THE FIGURES

For a better understanding of the embodiments and to show how it may be carried into effect, reference will now be made, purely by way of example, to the accompanying drawings.

With specific reference now to the drawings in detail, it is stressed that the particulars shown are by way of example and for purposes of illustrative discussion of selected embodiments only, and are presented in the cause of providing what is believed to be the most useful and readily understood description of the principles and conceptual aspects. In this regard, no attempt is made to show structural details in more detail than is necessary for a fundamental understanding; the description taken with the drawings making apparent to those skilled in the art how the various selected embodiments may be put into practice. In the accompanying drawings:

FIG. 1A is a schematic representation of a trading platform and associated system components for providing automatic matching and transfers of goods;

FIG. 1B is a schematic representation of possible information flow between trading parties and the trading platforms for facilitating transfer of items between multiple parties based upon exchanged proposals;

FIG. 2A is a simplified schematic block diagram illustrating a simple trading network including only two exchange-proposals connected by two matching-pairs;

FIG. 2B is another schematic block diagram illustrating another trading network including three exchange-proposals connected by three matching-pairs;

FIG. 2C is still another schematic block diagram illustrating another closed trading network including multiple exchange-proposals connected by multiple matching-pairs;

FIG. 2D is still another schematic block diagram illustrating an open trading network including multiple exchange-proposals connected by multiple matching-pairs;

FIG. 3 is a schematic representation of an example of items from a new match being joined to existing exchange chains via new transfers;

FIGS. 4A-C are schematic block diagram representations of an example of combining two exchange graphs together;

FIG. 5 is an illustration of a method for facilitating transfer of items between multiple parties based upon exchanged proposals;

FIGS. 6A-B are illustrations of methods for establishing a trading network of the connected exchange-proposals, as indicated in the flowchart of FIG. 5;

FIG. 7A is an illustration of a method for connecting at least two open exchange graphs of the candidate set as indicated in flowchart of FIG. 6B;

FIG. 7B is an illustration of a method providing possible additional steps when connecting at least two open exchange graphs of the candidate set, as indicated in the flowchart of FIG. 6B; and

FIG. 8 is an illustration of a method for combining two exchange graphs where each exchange graph includes at least one exchange-proposal.

### DETAILED DESCRIPTION

Aspects of the present disclosure relate to systems and methods for transferring goods between users via a network of nodes and edges wherein each node represents an exchange-proposal including a set of proffered items and an associated set of requested-items. Accordingly, methods are presented for generating closed cycles of item transfers between nodes such that each item in each set of proffered items in each of the nodes of the cycle and each associated set of requested-items in each of the nodes of the cycle are linked via a matching-pair to a corresponding item from another node. In particular a method is described for connecting each new exchange-proposal a user makes via matching-pairs to all possible chains existing in the system.

In various embodiments of the disclosure, one or more tasks as described herein may be performed by a data processor, such as a computing platform or distributed computing system for executing a plurality of instructions. Optionally, the data processor includes or accesses a volatile memory for storing instructions, data or the like. Additionally or alternatively, the data processor may access a non-volatile storage, for example, a magnetic hard-disk, flash-drive, removable media or the like, for storing instructions and/or data.

It is particularly noted that the systems and methods of the disclosure herein may not be limited in its application to the details of construction and the arrangement of the components or methods set forth in the description or illustrated in the drawings and examples. The systems and methods of the disclosure may be capable of other embodiments, or of being practiced and carried out in various ways and technologies.

Alternative methods and materials similar or equivalent to those described herein may be used in the practice or testing of embodiments of the disclosure. Nevertheless, particular methods and materials are described herein for illustrative purposes only. The materials, methods, and examples are not intended to be necessarily limiting.

### DESCRIPTION OF THE EMBODIMENTS

As used herein the term ‘trading party’ or ‘user’ refers to an entity posting items for trade by adding an exchange-proposal to the trading platform. The term ‘user’ may be used interchangeably with the term ‘trading party’.

As used herein the term ‘item’ refers to an item a user had offered or requested for trade.

As used herein the term ‘exchange-proposal’ refers to a structure including two sets: an offered item set and a requested-item set. A user may make exchange-proposals. Each exchange-proposal may represent a node in the chain graph.

As used herein the term ‘chain’ refers to a structure consisting of a set of exchange-proposals and a set of matching-pairs. The chain may represent a directional graph and a potential exchange between multiple users (trading parties) in a system. The term ‘graph’ may be used interchangeably with the term ‘chain’.

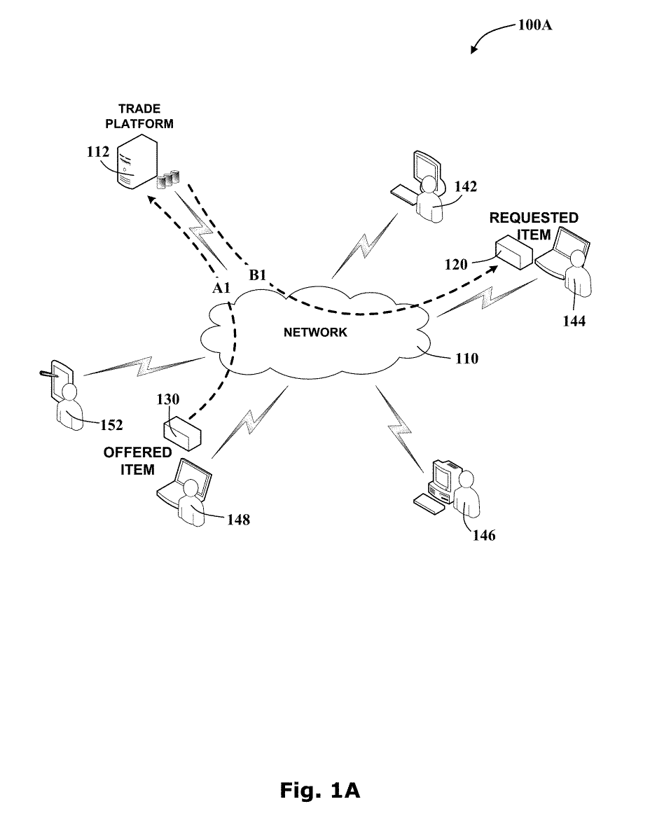

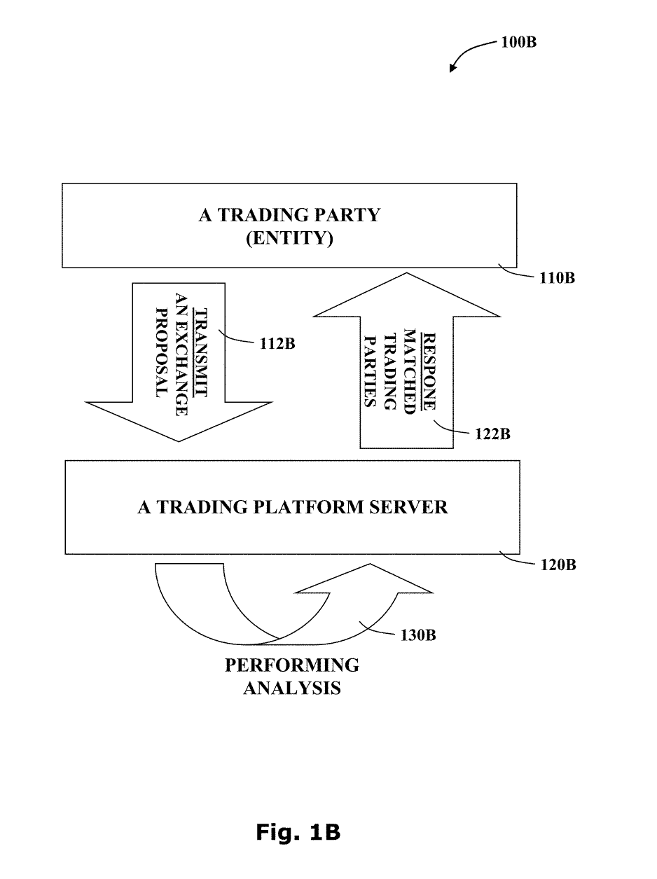

Reference is now made to FIG. 1A, there is provided a schematic view illustrating a trading platform system, which is generally indicated at 100A, the trading platform 100A is operable to provide automatic matching and transfers by connecting each new exchange-proposal or a matching-pair of sets of items a user makes via transfers to all possible exchange chains existing in the system. The trading platform is configured to receive exchange-proposals, in which an exchange-proposal is associated with a trading party, identify a matching-pair, establish a trading network of matching-pairs and exchange-proposals, collect from each trading party the offered items and further to transfer these offered items to other trading parties within the trading network requesting them.

The trading platform 100A comprises a trading platform server 112 operable to communicate with various types of user communication devices 142, 144, 146, 148, 150, 152, for example, via the network 110, each user may be a trading party who may provide ‘offered items’ such as offered item 130 offered by user 148 in return of requested-items. Each user, as a trading party may submit a request for a ‘requested-item’, such as the requested-item 120 requested by user 144. Thus, the channels A1 representing the offered item 130 and the channel B1 representing the requested-item 120 indicate a matching-pair which may allow for the item transfer.

Reference is now made to the diagram of FIG. 1B, there is provided a schematic illustrating possible information flow, which is generally indicated at 100B, the information flow 100B is between a trading party and at least one trading platform server for facilitating transfer of items between multiple trading parties based upon exchange-proposals (as described hereinafter). The schematic representation of possible information flow 100B includes a trading party 110B transmitting, via an electrical communication device, an exchange-proposal communication 112B to at least one trading platform server 120B. The at least one trading platform server 120B is operable to perform continual analysis 130B, responding with matched trading partners linked via matching-pairs 122B such that the trading network can be established and allow providing to each trading party registered in the trading network the requested-items in exchange to the set of offered items.

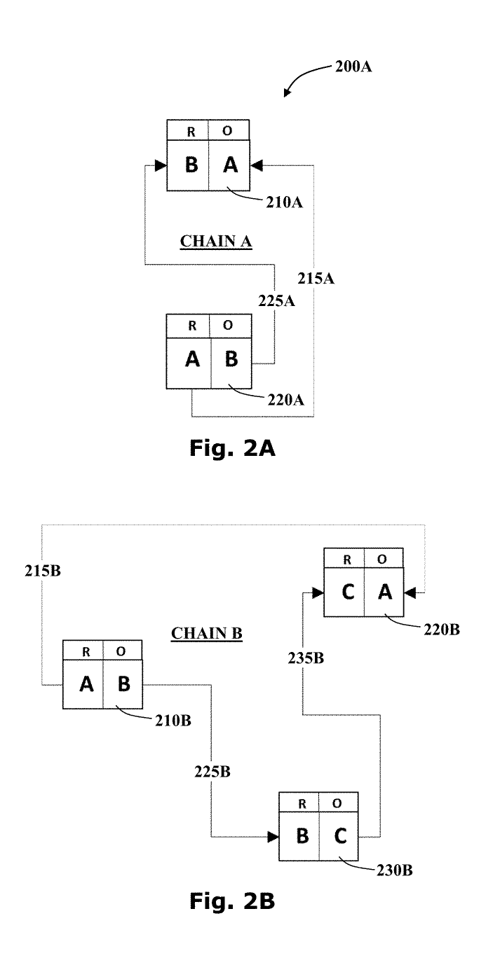

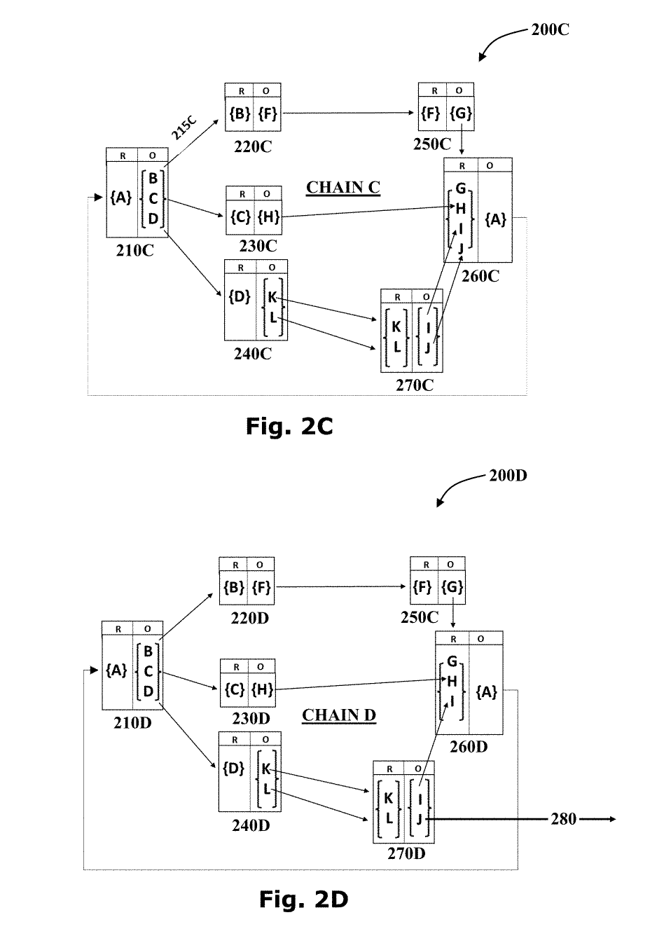

Reference is now made to FIG. 2A, there is provided a basic schematic diagram illustrating a simple trading network including only two exchange-proposals connected by two associated matching-pairs, which is generally indicated at 200A. The trading network 200A includes a first exchange-proposal 210A and a second exchange-proposal 220A. The first exchange-proposal 210A has an offered set O containing one offered item “A”, and a requested set R including one requested-item “B”. The second exchange-proposal 210B has an offered set O containing one offered item “B”, and a requested set R including one requested-item “A”. Thus, arrow line 215A indicates the first matching-pair linking the offered item “A” from the first exchange-proposal with the matching requested-item “A” from the second exchange-proposal. Similarly, arrow line 225A indicates the second matching-pair linking the offered item “B” from the second exchange-proposal with the matching requested-item “B” from the first exchange-proposal.

It is noted that the schematic diagram 200A results in a closed exchange-graph or closed exchange chain, as described hereinafter.

It is a particular feature of the current invention that unlike traditional two party bartering systems, the trading platform described herein allows for the exchange of items between more than two trading parties. Thus the giving party does not necessarily receive requested-items back from the receiving party to whom it gives.

Further unlike current multi-party bartering systems, the current invention allows giving and receiving items from multiple parties in the same exchange, allowing for greater flexibility and better value matching.

Reference is now made to FIG. 2B, illustrating another trading network, which is generally indicated at 200B, including three exchange-proposals connected by three matching-pairs. The trading network 200B includes a first exchange-proposal 210B, a second exchange-proposal 220B and a third exchange-proposal 230B. The first exchange-proposal 210B has a requested set R containing one requested-item “A”, and an offered set O including one offered item “B”. The second exchange-proposal 220B has a requested set R containing one requested-item “C”, and an offered set O including one offered item “A”. The third exchange-proposal 230B has a requested set R containing one requested-item “B”, and an offered set O including one offered item “C”. Thus, arrow line 215B indicates the first matching-pair of “A” item, linking the requested-item “A” from the second exchange-proposal with the matching requested-item “A” from the first exchange-proposal, the arrow line 225B indicates the second matching-pair of “B” item, linking the offered item “B” from the first exchange-proposal with the matching requested-item “B” from the second exchange-proposal and arrow line 235B indicates the first matching-pair of “C” item, linking the offered item “C” from the third exchange-proposal with the matching requested-item “C” from the second exchange-proposal.

It is noted that the trading network 200B results in a closed exchanged chain, as described hereinafter.

Similarly, FIGS. 2C-D represent more complex illustrations of trading networks having a plurality of exchange-proposals resulting in a different type of exchanged chain.

As illustrated in FIG. 2C, there is provided yet another schematic diagram illustrating a trading network having multiple exchange-proposals 210C, 220C, 230C, 240C, 250C, 260C, 270C, and associated matching-pairs forming a closed trading network, which is generally indicated at 200C. Each proposed item of a trading party is matched with a requested-item of another trading party. For example, a first exchange-proposal 210C has a requested set R containing one requested-item “A”, and an offered set O including offered items “B”, “C” and “D”. A second exchange-proposal 220C has a requested set R containing one requested-item “B”, and an offered set O including one offered item “F”. The arrow line 215C indicates the a matching-pair of “B” item, linking the offered item “B” from the first exchange-proposal with the matching requested-item “B” from the second exchange-proposal.

It is noted that the trading network may be considered as a trading-graph having trading-nodes corresponding to exchange-proposals and trading-edges corresponding to matching pairs linking two trading-nodes.

As illustrated in FIG. 2D, there is provided still another schematic diagram illustrating an open trading network, which is generally indicated at 200D, the open trading network 200D having multiple exchange-proposals 210D, 220D, 230D, 240D, 250D, 260D, 270D, and associated matching-pairs forming an open trading network. Each proposed item of a trading party is being matched with a requested-item of another trading party, apart from the offered item “J” of one exchange-proposal 270D which has no match.

Accordingly, the open trading network of FIG. 2D is characterized by a trading-node corresponding to an unexhausted exchange-proposal 270D which has an unbound proffered-item J which is not linked to any matching-pair. It will be appreciated that, similarly, other open trading graphs may include unbound requested-items.

It is noted the where there is no match to the items offered it may be saved as an empty transfer, thus forming an open exchange-graph. Accordingly, the open trading network 200D is an open exchange chain and may be characterized by an offered pointer 280 indicating an item offered by the open trading network.

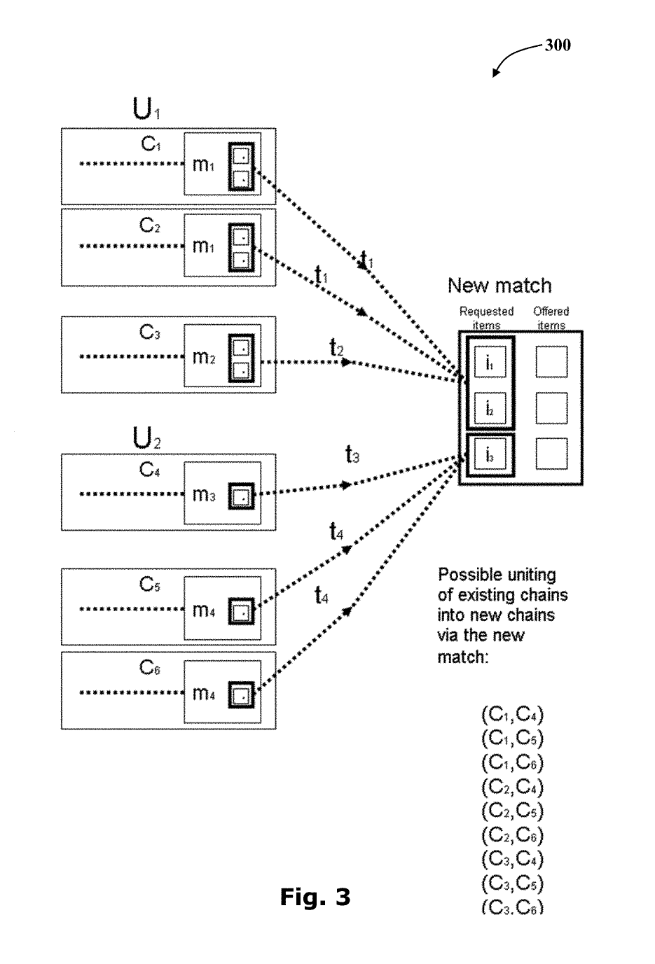

Reference is now made to FIG. 3, there is provided a block diagram illustrating a trading platform matching process, which is generally indicated at 300, the trading platform is operable to provide automatic matching and transfers by connecting a new match or matching-pair of sets of items provided by a user (a trading party) when introducing a new exchange-proposal. The block diagram 300 includes a set of open exchange chains (C₁, C₂, C₃) associated with a trading party U1, and a second set of open exchange chains (C₄, C₅, C₆) associated with another trading party U2.

When a new exchange-proposal, comprising a set of at least one requested-item and a set of at least one offered item, is introduced into the system, new options become available to merge exchange chains. Accordingly, open exchange chains may potentially be joined to form a closed exchange chain, such that a transfer of goods may become operable.

As described in block diagram 300, upon the introduction of the new exchange-proposal, the following merging options may become valid. For example, combining of (C₁, C₄) where the C₁ chain is associated with the trading party U₁ and the C₄ is associated with trading party U₁. Similarly, combining of (C₁, C₅) where the C₁ chain is associated with the trading party U₁ and the C₅ is associated with trading party U₁. Other possible combinations may take place, such as (C₁, C₆), (C₂, C₄), (C₂, C₅), (C₂, C₆), (C₃, C₄), (C₃, C₅) and (C₃, C₆). Each such combination will extend the open exchange chain to allow additional transfers. Thus, an associated method may be used in the embodiment for connecting each new exchange-proposal via matching-pairs to all possible chains existing in the system.

Accordingly, for every user (a trading party) that offers an item or more requested in the new exchange-proposal, for every exchange chain having an offered pointer that offers those items, a matching-pair is created linking that exchange chain and the new exchange-proposal. A set of new exchange chains may be generated by adding the new matching-pair element to every exchange chain which includes that offered pointer.

Where appropriate, for the first matching-pair created, the new exchange-proposal is simply added to the mentioned chains and to the transfer's offered match.

Where there is no match to the items offered it may be saved as an empty transfer and is added to all the existing chains of the new exchange-proposal.

For the next matching-pairs, the exchange chains of the offered match and the chains the new exchange-proposal (requested chains) which were previously added are added together in a Cartesian manner such that in every offered exchange chain is combined with a copy of the requested exchange chains and vice versa. Accordingly the number of chains generated may be given as the product of the number of offered chains and the number of requested chains.

It is noted that, for every two chains that are to be merged in this manner there is a possibility that there are one or more incompatible exchange-proposal that have either an offered item which is also offered in an exchange-proposal in the other chain or have a requested item which is also requested in an exchange-proposal in the other chain (hence incompatible trading-nodes). The following describes how to handle those incompatible exchange-proposals.

Incompatible trading-nodes are identified in a first open exchange-graph which include proffered-items in common (or requested-items in common) with at least one corresponding incompatible trading-node in the second open exchange-graph.

Then a merged exchange-graph is created for each combination of the incompatible trading-nodes identified in the first open exchange-graph. This is achieved by creating a copy of the first open exchange-graph and removing that particular combination of incompatible trading-nodes. Then for all the incompatible trading-nodes remaining of the first open exchange-graph, all the corresponding incompatible trading-nodes are removed from the second open exchange-graph. Then the two open exchange-graphs may be connected via a matching-pair or another exchange proposal as appropriate.

It is further noted that where there are dependent trading nodes connected to an open exchange-graph via a removed incompatible trading-node, the open exchange-graph will be split into two sections. In such cases only the section including the unexhausted exchange-proposal will be merged to the other open exchange-graph and the second section may be discarded.

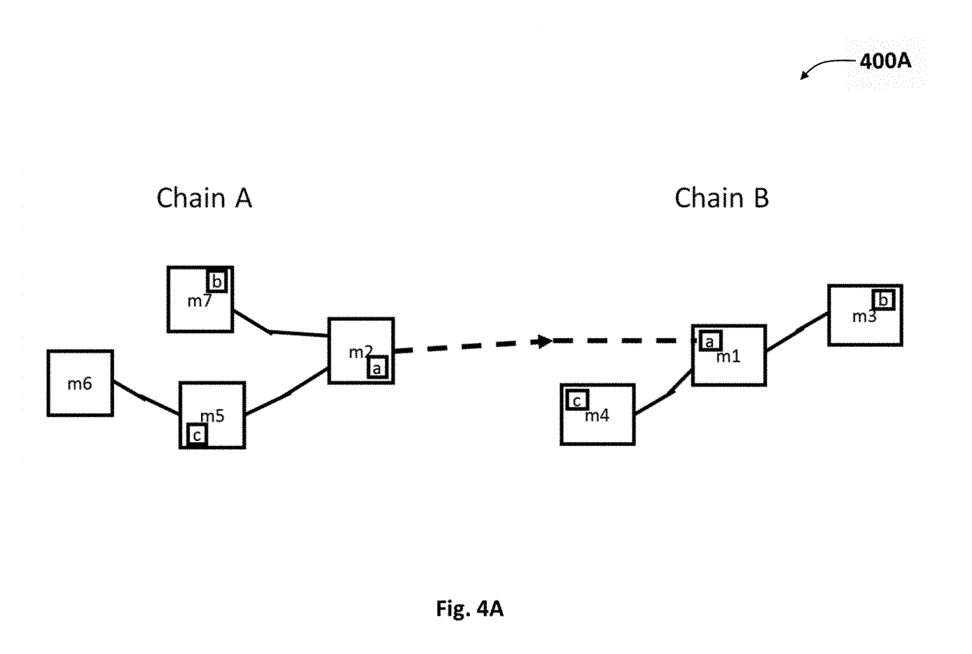

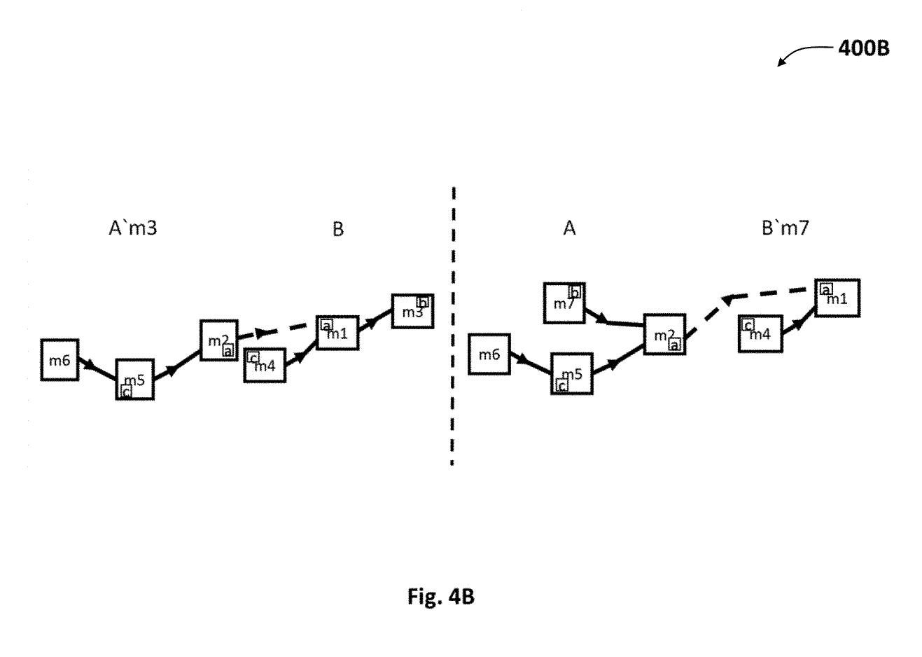

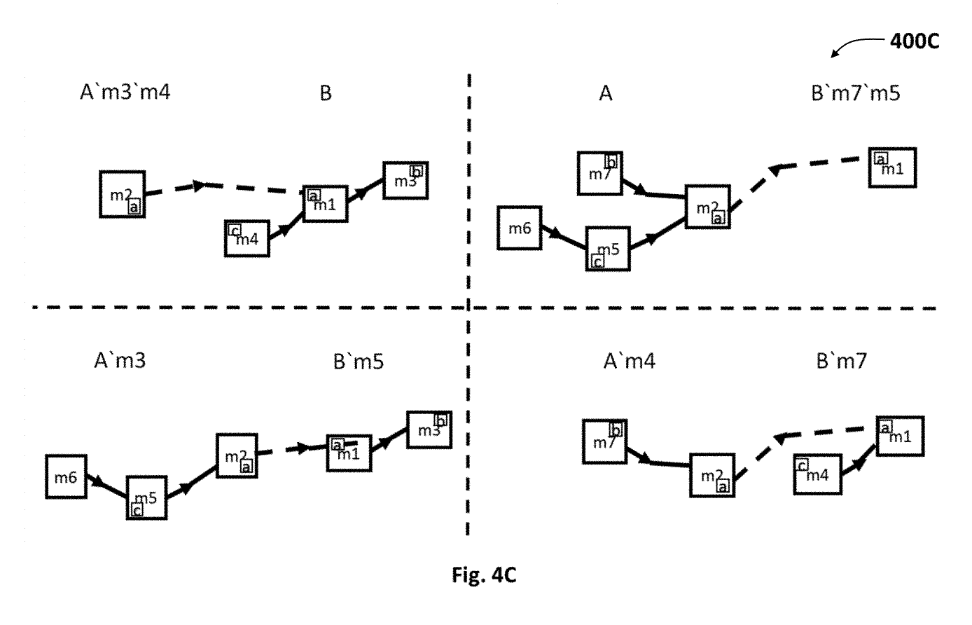

By way of example, reference is now made to FIG. 4A, there is provided a chain block diagram illustrating two exchange chains (A, B), which is generally indicated at 400A, in which the two exchange chains need to be connected to one another.

Let (A, B) be two exchange chains that need to be connected to one another, and m1(A) be an exchange-proposal in A that is incompatible with one or more exchange-proposals in B. Let B′(m1(A)) be a copy of B without the incompatible matches. Similarly let A′(m1(B)) be a copy of A without the incompatible matches.

Accordingly, as illustrated in FIG. 4B, there is provided a block diagram illustrating the created exchange chains, which is generally indicated at 400B, showing two new possible pair of chains after removing those exchange-proposals from the copies of either exchange chain. The two new possible pairs of exchange chains are:

1. (A, B′(m1(A))) and

2. (A′(m1(B)), B).

When deleting the incompatible matches, it is possible that the exchange chain would be split into two or more parts by the removal, in this case all the parts that are not connected to either the offered exchange-proposal (in the offered chain) or the new exchange-proposal (in the requested exchange chain) are removed.

Further, and as illustrated in FIG. 4C, there is provided another block diagram illustrating the merged exchange graphs, which is generally indicated at 400C. As shown in the diagram 400C, the process is repeated on those two new pairs (indicated by “A” and “B”, FIG. 4B), searching for exchange-proposals in one chain that are incompatible with one or more exchange-proposals in the other and removing them from a copy of the other exchange chain, if there's another exchange-proposal in A which is incompatible with some in B′(m1(A)) and vice versa, we'll get four pairs of exchange chains:

1. (A, B′(m1(A))′(m2(A))),

2. (A′(m1(B)), B′ m2(A))),

3. (A′ m2(B)), B′(m1(A))), and

4. (A′(m1(B))′ m2(B)), B)

In some cases, m1(B)=m2(B) and m1(A)=m2(A), making the two middle pairs identical, so on every such step it may be appropriate to check if an identical exchange chain exists in the existing pairs of exchange chains (by comparing the sets of exchange-proposals), and delete the new pair, so as to not have any duplicates.

The process is repeated until no incompatibilities exist between the exchange chains in every pair, then the pairs are combined into a single new chain each.

Where a similar exchange chain had already been created from another previous iteration on pair of chains, it may be appropriate to check against all the created chains of the new exchange-proposals and delete the new exchange chain if a similarity is found.

A similar process as that for the new exchange-proposal, is applied to all exchange-proposals requesting an item or more from the items that are offered in the new exchange-proposal (where the new exchange-proposal is the offered exchange-proposal), all their empty transfers or new copies of matching-pairs connected to the offered items of other exchange-proposals connect to the variations of the exchange chains of the offered exchange-proposals and the exchange chains of the requested exchange-proposal.

For each exchange chain a reference is kept to a set of unexhausted exchange-proposals which don't have all their items bound by matching-pairs (for that specific exchange-chain), if there is no unexhausted exchange-proposals in that set, the exchange chain is closed, and its associated trading parties may commence the exchange.

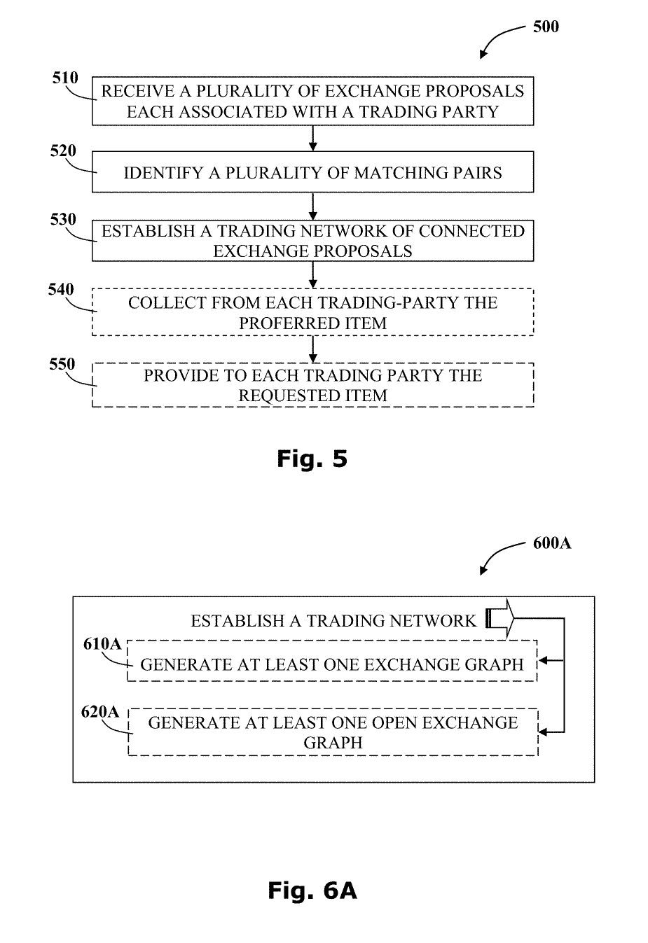

As illustrated in FIG. 5, a method may be provided, which is generally indicated at 500, for facilitating transfer of items between multiple parties based upon exchanged proposals, as indicated in FIG. 1, by executing appropriate software on a trading platform (FIG. 1, item 112) communicating with a computing device associated with each trading party (FIG. 1, items 142, 144, 146, 148 and 152) via the network (FIG. 1, item 110).

It is noted that aspects of the present disclosure relate to a system for transferring goods between users (referred to as trading parties) via a network of nodes and edges wherein each node represents an exchange-proposal including a set of offered items and an associated set of requested items.

In step 510 of the method 500, the trading platform 112 is receiving a plurality of exchange-proposals, each exchange-proposal associated with a trading party and characterized by a request set including at least one requested-item, and a proffered set including at least one proffered-item.

In step 520 of the method 500, the trading platform 112 is identifying a plurality of matching-pairs, each said matching-pair linking at least one proffered-item selected from the proffered set of a first exchange-proposal and a matching requested-item selected from the requested set of a second exchange-proposal.

In step 530 of the method 500, the trading platform 112 is establishing a trading network of connected exchange-proposals, linked by the matching-pairs such that each of the proffered-item of each of the connected exchange-proposal is paired with at least one requested-item from another connected exchange-proposal and each of the requested-item of each connected exchange-proposal is paired with at least one proffered-item from another connected exchange-proposal.

Optionally, in step 540 of the method 500, the trading platform 112 is collecting from each trading party associated with each said connected exchange-proposal in said trading network the proffered-items in its associated proffered set; and

In step 550 of the method 500, the trading platform 112 is providing to each trading-party associated with each said connected exchange-proposal in said trading-network the requested-items in its associated requested-set.

As illustrated in FIG. 6A, a method may be provided, which is generally indicated at 600B, for establishing a trading network of the connected exchange-proposals, as indicated in the flowchart of FIG. 5.

In step 610A of the method 600A, the trading platform 112 is generating at least one exchange graph having trading nodes and trading edges wherein each trading node corresponds with a single exchange-proposal and each trading edge corresponds with a matching-pair linking two of the nodes.

Typically, as indicated in step 620A of the method 600A, in order to achieve a closed trading network, the trading platform 112 generates at least one open exchange graph characterized by having at least trading node corresponding to an unexhausted exchange-proposal having an unbound requested-item which is not linked to any matching-pair.

As illustrated in FIG. 6B, a method may be provided, which is generally indicated at 600B, for establishing a trading-network of the connected exchange-proposals, as indicated in the flowchart of FIG. 5.

In step 610B of the method 600B, the trading platform 112 receives a new exchange-proposal.

In step 620B of the method 600B, the trading platform 112 identifies exchange-graphs including at least one matching requested-item corresponding to at least one item in the proffered set of the new exchange-proposal or at least one matching proffered-item corresponding to at least one item in the requested set of the new exchange-proposal

In step 630B of the method 600B, the trading platform 112 generating at least one new open exchange graph for each proffered-item in the proffered set of the new exchange-proposal, by generating a new matching-pair to an unbound requested-item from an unexhausted exchange-proposal in one of the open exchange graphs selected from the established candidate set of the open exchange graphs.

The method 600B may further include the one following steps or a combination thereof:

In step 640B of the method 600B, the trading platform 112 is generating a new set of open exchange graphs comprising a plurality of the new open exchange graphs; and

In step 650B of the method 600B, the trading platform 112 is connecting at least two the open exchange graphs the candidate set via a new exchange-proposal having at least a first proffered-item connected to a first open exchange graph and a second proffered-item connected to a second open exchange graph.

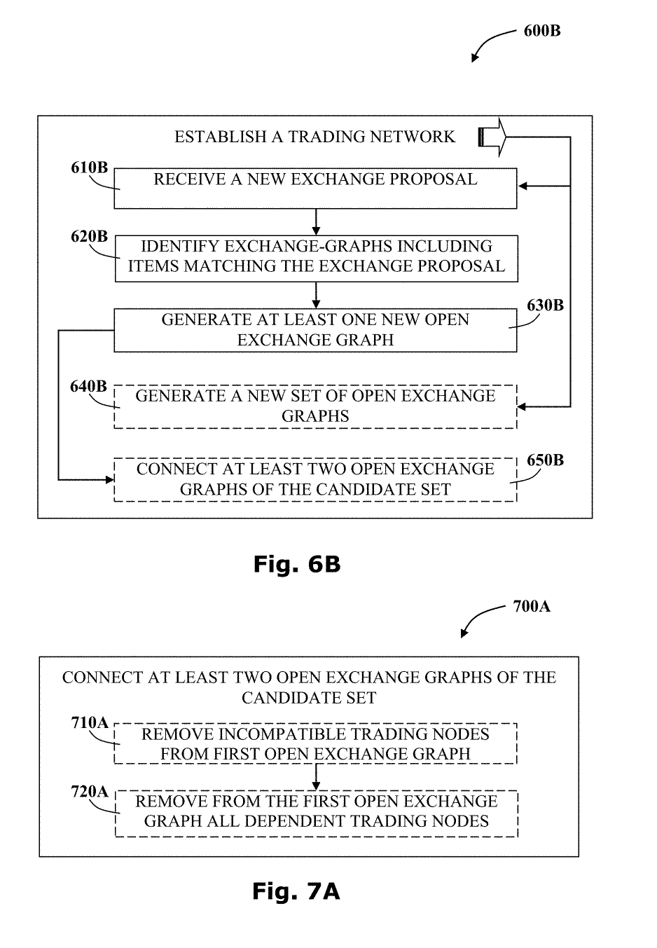

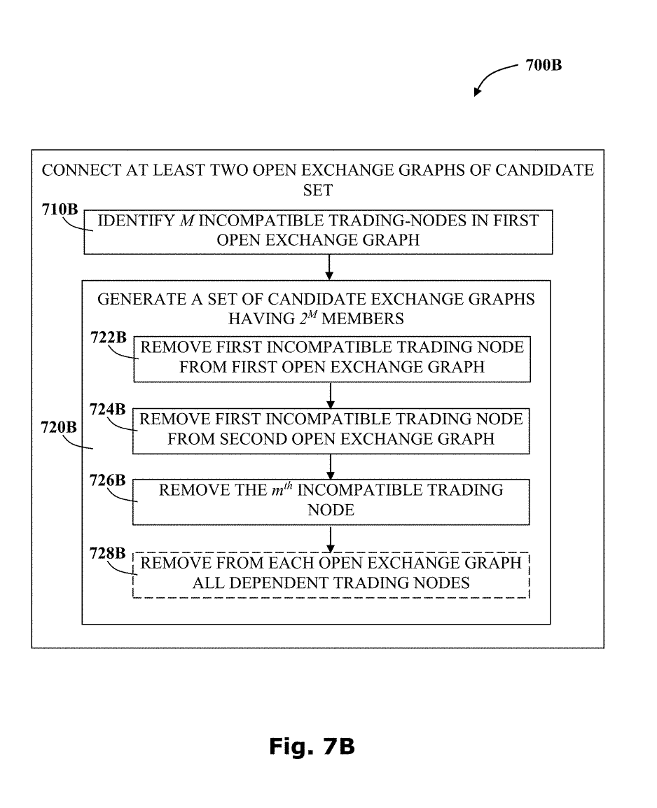

As illustrated in FIG. 7A, a method may be provided, which is generally indicated at 700A, for connecting at least two open exchange graphs of the candidate set, as indicated in the flowchart of FIG. 6B.

In step 710A of the method 700A, the trading platform 112 is removing incompatible trading nodes from the first open exchange graph which correspond to the same exchange-proposal as another trading node in the second open exchange graph.

Typically, as illustrated in step 720A of the method 700A, the trading platform 112 further removes from the first open exchange graph all dependent trading nodes connected to the exchange-graph via the incompatible trading nodes.

As illustrated in FIG. 7B, another method may be provided, which is generally indicated at 700B, indicating possible additional steps when connecting the two open exchange graphs, as indicated in the flowchart of FIG. 6B.

In step 710B of the method 700B, the trading platform 112 is identifying M incompatible trading-nodes in the first open exchange-graph which correspond to the same exchange-proposal as another trading-node in the second open exchange-graph; and

In step 720B of the method 700B, the trading platform 112 is generating a set of candidate exchange graphs having 2^{M} members, by following sub-steps:

In step 722B, the trading platform 112 is removing the first incompatible trading node from the first open exchange graph thereby generating a first candidate exchange graph;

In step 724B, the trading platform is removing the first incompatible trading node from the second open exchange graph thereby generating a second candidate exchange-graph; and

In step 726B, the trading platform 112 is removing the first incompatible trading node from the second open exchange graph, thereby generating a second candidate exchange graph; and removing the m^{th} incompatible trading node from each of the first open exchange graph and the second open exchange graph segments of each of 2^{M-1} candidate exchange chains generated by removing the (m-1)^{th} incompatible trading node from each of the first open exchange graph and the second open exchange graph.

Optionally, in step 728B, the trading platform 112 removes from the each open exchange graph all dependent trading nodes connected to said incompatible trading nodes. It is noted that the step 728B may further include identifying at least two identical members of the set of candidate exchange chains; thereafter removing all duplicates of the identical members.

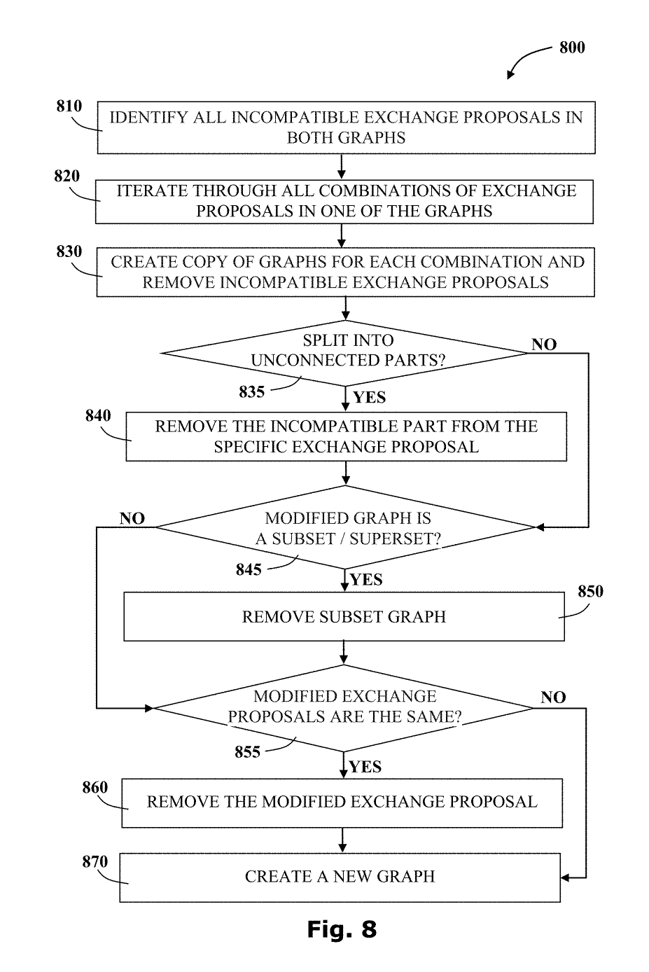

As illustrated in FIG. 8, a method may be provided, which is generally indicated at 800, for combining two exchange graphs where each exchange graph includes at least one exchange-proposal.

In step 810 of the method 800, the trading platform 112 is identifying all the incompatible exchange-proposals in both graphs.

In step 820 of the method 800, the trading platform 112 is iterating over all the possible mathematical combinations of incompatible exchange-proposals in one of the graphs.

In step 830 of the method 800, the trading platform 112, creates a new copy of each of the two exchange graphs, for each combination of incompatible exchange nodes in the first graph. The combination of incompatible exchange-proposals are all removed from the first graph. For each of the remaining incompatible exchange-proposals on the first graph, the corresponding incompatible proposals are removed from the second graph.

In step 835 of the method 800, the trading platform 112, is testing if the removal of the exchange-proposal resulted in an exchange graph which is being split into disconnected sections.

If yes, in step 840 of the method 800, the trading platform 112, removes the section which is not connected to either the requested exchange-proposal in the requested exchange graph or the offered proposal in the offered exchange graph.

In step 845 of the method 800, the trading platform 112, is testing if the exchange-proposals of the two modified exchange graphs are a subset of one of the exchange graphs already created from the two original exchange graphs in this process, or a super set. A subset is an exchange graph all of whose trading-nodes already exist in another exchange graph. A superset is an exchange graph containing all the trading-nodes of another exchange graph.

In step 850 of the method 800, the trading platform 112, is deleting the exchange-proposals if they are a subset, and the exchange graph is deleted in the case where the exchange-proposals are a superset of the exchange graph.

In step 855 of the method 800, the trading platform 112, is testing if the exchange-proposals are the same as the exchange-proposals of an exchange graph that was created previously from a different set of two exchange graphs.

Then, in step 860 of the method 800, the trading platform 112, is discarding the modified exchange-proposals; and

Thereafter, in step 870 of the method 800, the trading platform 112, is creating a new exchange graph comprising of both modified exchange graphs (connecting them via the new matching-pair).

It is noted that this may create at most 2^{N} new graphs, where N is the smallest number of incompatible exchange-proposals of the two graphs in question.

### Item Delivery Coordination

It will be appreciated that once a complete trading network has been established, it may be important to manage the delivery of all items to the appropriate trading party in a synchronized manner.

Coordinated delivery management may be used to assure against a trading party receiving requested-items without providing proffered-items as promised. Thus proffered-items may be collected before requested-items are provided. It is further noted that if a trading-party fails to provide a promised proffered-item all trades may be recalled, such that proffered-items are returned to their trading party of origin, preferably before they are delivered.

Accordingly, it may be appropriate to send a prompt for payment for the delivery to all trading-parties associated with all exchange-proposals corresponding to trading-nodes within the complete trading network. The payment for delivery may be used to indicate a final commitment to the trade.

Once all trading parties have paid for the delivery of their goods, a staggered delivery schedule may be effected. The staggered delivery may be calculated according to the estimated time it takes to deliver each set of items from the proffering trading party to the requesting trading party. Orders may be placed in sequence according to the length of time of the delivery (t(1), t(2), t(3) t(n)), where t(1) is the longest delivery and t(n) is the shortest.

Accordingly, items are first collected from and sent to the trading parties that take time t(1) to deliver. Then after a time t(1)-t(2) items are collected from and sent to the trading parties that take time t(2) to deliver, and so on until the last items are collected from and sent to the trading parties that take time t(n) after a time equal to t(1)-t(n). In this way all the items may arrive at their receivers simultaneously after within a period of time equal to t(1).

By way of illustration only, in one example an exchange chain may involve three trading-parties, say, one in the US and two in Israel. If the delivery to and from the US takes 10 days and inside Israel it takes one day, then the deliveries from and to the US are sent on the same day first, and the delivery between the parties in Israel on day 19 so that all the items arrive at the same time.

Those skilled in the art to which this invention pertains will readily appreciate that numerous changes, variations and modifications can be made without departing from the scope of the invention mutatis mutandis.

Technical and scientific terms used herein should have the same meaning as commonly understood by one of ordinary skill in the art to which the disclosure pertains. Nevertheless, it is expected that during the life of a patent maturing from this application many relevant systems and methods will be developed. Accordingly, the scope of the terms such as computing unit, network, display, memory, server and the like are intended to include all such new technologies a priori.

As used herein the term “about” refers to at least ±10%.

The terms “comprises”, “comprising”, “includes”, “including”, “having” and their conjugates mean “including but not limited to” and indicate that the components listed are included, but not generally to the exclusion of other components. Such terms encompass the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” may include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments or to exclude the incorporation of features from other embodiments.

The word “optionally” is used herein to mean “is provided in some embodiments and not provided in other embodiments”. Any particular embodiment of the disclosure may include a plurality of “optional” features unless such features conflict.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween. It should be understood, therefore, that the description in range format is merely for convenience and brevity and should not be construed as an inflexible limitation on the scope of the disclosure. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6 as well as non-integral intermediate values. This applies regardless of the breadth of the range.

It is appreciated that certain features of the invention, which are, for clarity, described in the context of separate embodiments, may also be provided in combination in a single embodiment. Conversely, various features of the disclosure, which are, for brevity, described in the context of a single embodiment, may also be provided separately or in any suitable sub-combination or as suitable in any other described embodiment of the disclosure. Certain features described in the context of various embodiments are not to be considered essential features of those embodiments, unless the embodiment is inoperative without those elements.

Although the invention has been described in conjunction with specific embodiments thereof, it is evident that other alternatives, modifications, variations and equivalents will be apparent to those skilled in the art. Accordingly, it is intended to embrace all such alternatives, modifications, variations and equivalents that fall within the spirit of the invention and the broad scope of the appended claims.

Additionally, the various embodiments set forth hereinabove are described in term of exemplary block diagrams, flow charts and other illustrations. As will be apparent to those of ordinary skill in the art, the illustrated embodiments and their various alternatives may be implemented without confinement to the illustrated examples. For example, a block diagram and the accompanying description should not be construed as mandating a particular architecture, layout or configuration.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a computer-readable medium such as a storage medium. Processors may perform the necessary tasks.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present disclosure. To the extent that section headings are used, they should not be construed as necessarily limiting.

The scope of the disclosed subject matter is defined by the appended claims and includes both combinations and sub combinations of the various features described hereinabove as well as variations and modifications thereof, which would occur to persons skilled in the art upon reading the foregoing description.

1. A method for facilitating transfer of items between multiple parties, the method comprising:
receiving a plurality of exchange-proposals, each exchange-proposal associated with a trading-party and characterized by a request-set including at least one requested-item, and a proffered-set including at least one proffered-item;
identifying a plurality of matching-pairs, each said matching-pair linking at least one proffered-item selected from the proffered-set of a first exchange-proposal and at least one matching requested-item selected from the requested-set of a second exchange-proposal; and
establishing a trading-network of connected exchange-proposals, linked by said matching-pairs such that each said proffered-item of each said connected exchange-proposal is paired with a requested-item from another connected exchange-proposal and each said requested-item of each connected exchange-proposal is paired with a proffered-item from another connected exchange-proposal.

2. The method of claim 1 further comprising:
collecting from each trading-party associated with each said connected exchange-proposal in said trading-network the proffered-items in its associated proffered-set; and
providing to each trading-party associated with each said connected exchange-proposal in said trading-network the requested-items in its associated requested-set.

3. The method of claim 1 wherein the step of establishing a trading-network comprises generating at least one exchange-graph having trading-nodes and trading-edges wherein each trading-node corresponds with a single exchange-proposal and each said trading-edge corresponds with a matching-pair linking two said trading-nodes.

4. The method of claim 3 further comprising:
identifying at least two identical exchange-graphs; and
removing all duplicates of said exchange-graphs.

5. The method of claim 3 further comprising removing any exchange-graph all of whose trading-nodes are a subset of the trading-nodes of another exchange-graph.

6. The method of claim 3 wherein the step of establishing a trading-network further comprises generating at least one open exchange-graph characterized by having at least one trading-node corresponding to an unexhausted exchange-proposal having at least one unbound requested-item or at least one unbound proffered-item which is not linked to any matching-pair.

7. The method of claim 3 wherein the step of establishing a trading-network comprises:
receiving a new exchange-proposal;
identifying exchange-graphs which include at least one matching requested-item corresponding to at least one proffered-item in the proffered set of the new exchange-proposal, and for each said at least one matching requested-item, creating a new matching-pair between the at least one matching requested-item and the at least one proffered-item of the new exchange-proposal; and
identifying exchange-graphs which include at least one matching proffered-item corresponding to at least one requested-item in the requested set of the new exchange-proposal, and for each said at least one matching proffered-item, creating a new matching-pair between the at least one matching proffered-item and the at least one requested-item of the new exchange-proposal.

8. The method of claim 3 wherein the step of establishing a trading-network further comprises creating a merged exchange-graph by connecting a first exchange-graph and a second exchange-graph.

9. The method of claim 8 wherein the step of connecting the first exchange-graph and the second exchange-graph comprises creating a matching-pair matching at least one proffered-item from one exchange-graph and at least one matching requested-item from the other exchange-graph.

10. The method of claim 8 wherein the step of connecting the first exchange-graph and the second exchange-graph comprises:
creating a first matching-pair linking a new exchange-proposal to at least one proffered-item or requested-item from the first exchange-graph, and
creating a second matching-pair linking said new exchange-proposal to at least one proffered-item or requested-item from the second exchange-graph.

11. The method of claim 8 wherein creating a merged exchange-graph further comprises removing incompatible trading-nodes in the first exchange-graph which include proffered-items in common or requested-items in common with at least one corresponding incompatible trading-node in the second exchange-graph.

12. The method of claim 11 wherein connecting said open exchange-graphs further comprises removing any trading-nodes connected to the first exchange-graph or the second exchange-graph via the incompatible trading-nodes.

13. The method of claim 3 wherein the step of establishing a trading-network further comprises:
identifying incompatible trading-nodes in a first open exchange-graph which include proffered-items in common or requested-items in common with at least one corresponding incompatible trading-node in the second open exchange-graph; and
for each combination of incompatible trading-nodes in the first open exchange-graph, generating a merged exchange-graph by:
removing the combination of incompatible trading-nodes from a copy of the first open exchange-graph;
removing from a copy of the second open exchange-graph all incompatible trading-nodes corresponding to the incompatible trading-nodes remaining in the copy of the first open exchange graph;
removing any trading-nodes which were connected to the first open exchange-graph or the second open exchange-graph via the incompatible trading-nodes; and
connecting the copy of the first open exchange-graph and the copy of the second open exchange-graph.

14. The method of claim 13 wherein the step of connecting the copy of the first open exchange-graph and the copy of the second open exchange-graph comprises creating a matching-pair matching at least one proffered-item from one open exchange-graph and at least one matching requested-item from the other open exchange-graph.

15. The method of claim 13 wherein the step of connecting the copy of the first open exchange-graph and the copy of the second open exchange-graph comprises:
creating a first matching-pair linking a new exchange-proposal to at least one proffered-item or requested-item from the first open exchange-graph, and
creating a second matching-pair linking said new exchange-proposal to at least one proffered-item or requested-item from the second open exchange-graph.

16. The method of claim 13 further comprising removing any merged exchange-graph all of whose trading-nodes are a subset of the trading-nodes of another merged exchange-graph.

17. The method of claim 13 further comprising:
identifying at least two identical merged exchange-graphs; and
removing all duplicates of said merged exchange-graphs.

18. The method of claim 3 wherein the step of establishing a trading-network further comprises:
identifying incompatible trading-nodes in a first open exchange-graph which include proffered-items in common or requested-items in common with at least one corresponding incompatible trading-node in the second open exchange-graph; and
for each combination of incompatible trading-nodes in the first open exchange-graph, generating a merged exchange-graph by:
removing all the incompatible trading-nodes from a copy of the first open exchange-graph except for the trading-nodes of the combination;
removing from a copy of the second open exchange-graph all incompatible trading-nodes corresponding to the incompatible trading-nodes remaining in the copy of the first open exchange graph;
removing any trading-nodes which were connected to the first open exchange-graph or the second open exchange-graph via the incompatible trading-nodes; and
connecting the copy of the first open exchange-graph and the copy of the second open exchange-graph.

19. A trading platform for managing transfer of items between multiple trading-parties, said trading platform comprising:
a plurality of computing devices installable with a software application, each device associated with at least one trading party and operable to present an exchange-proposal characterized by a request-set including at least one requested-item and a proffered-set including at least one offered-item; and
at least one trading server in communication with each of said plurality of computing devices via a communication network and said software application, said at least one trading server operable to execute instructions directed to:
receive a plurality of exchange-proposals, each exchange-proposal associated with a trading-party;
identify a plurality of matching-pairs, each said matching-pair linking at least one proffered-item selected from the proffered-set of a first exchange-proposal and a matching requested-item selected from the requested-set of a second exchange-proposal; and
establish a trading-network of connected exchange-proposals, linked by said matching-pairs such that each said proffered-item of each said connected exchange-proposal is paired with at least one requested-item from another connected exchange-proposal and each said requested-item of each connected exchange-proposal is paired with at least one proffered-item from another connected exchange-proposal.

20. The trading platform of claim 19 further comprising:
a collection mechanism for collecting from each trading-party associated with each said connected exchange-proposal in said trading-network the proffered-items in its associated proffered-set; and
a delivery mechanism for providing to each trading-party associated with each said connected exchange-proposal in said trading-network the requested-items in its associated requested-set.
